(19) United States
(12) Patent Application Publication
(10) Pub. No.: US 2003/0074398 A1
(43) Pub. Date: Apr. 17, 2003

(54) Information providing system and method

(75) Inventor: Naoshi Matsuo, Kawasaki (JP)

Correspondence Address: STAAS & HALSEY LLP, 700 11TH STREET, NW, SUITE 500, WASHINGTON, DC, 20001, US

(73) Assignee: FUJITSU LIMITED, Kawasaki (JP)

(21) Appl. No.: 10/057,998

(22) Filed: Jan. 29, 2002

(30) Foreign Application Priority Data
Oct. 17, 2001 (JP) 2001-319337

(51) Int. Cl. G06F 15/16

(52) U.S. Cl. 709/203; 705/14

(57) ABSTRACT

A service providing server 100 provides information on goods and the like to an information brokering server 200, and stores it in an information storing part 210 (1). An information brokering part 220 receives an information search request from a user terminal 300 (2), searches the information storing part 210 for the corresponding information (3), brokers the information to the user terminal 300, gives the information search request and the contents of information brokering to a user access information control part 230 (5), creates user access information to the information brokering server 200 in an evaluating part 231, and notifies the service providing server 100 of the user access information. An incentive adjusting part 120 adjusts an incentive in accordance with the user access information (7), and an executing part 130 receives user ID information and a user request (8), and executes processing in accordance with the contents of the incentive (9).

### BACKGROUND OF THE INVENTION

1. Field of the Invention

The present invention relates to a system for providing information on service provided by a service providing server in accordance with a search request from a user. Herein, service provided by the service providing server refers to, for example, sales of goods at a shop, provision of work, on-line sales of goods on a network, on-line provision of information such as music distribution, and the like.

2. Description of the Related Art

Forms of commercial transactions are being varied as in on-line sales of goods on a network and on-line provision of information such as music distribution, as well as sales of goods and provision of work at a shop. It is important for these goods sales entities and work providing entities to let users know the contents of goods and work, and to promote the use thereof. Due to the development of the Internet, goods sales entities and work providing entities can establish a web server and transmit information on the goods and the contents of work, and send electronic mail to particular prime users individually as direct mail.

However, a great amount of labor and cost are required for goods sales entities and work providing entities to establish a web server and manage it. Furthermore, the number of users who access a web server established and managed by a small operation entity is limited. Furthermore, in the case where electronic mail is sent to individual users as direct mail, the users will receive electronic mail that is not necessary to them. In most cases, the users will be annoyed.

In view of the above, there is an information providing system that manages the contents of service provided by a goods sales entity and a work providing entity, and brokers information on the goods sold by the goods sales entity and the work provided by the work providing entity, in accordance with a search request from an accessing user.

FIGS. 5A and 5B show schematic configurations of a conventional information providing system.

Reference numeral 500 denotes a service providing server. A goods sales entity or a work providing entity uses the service providing server 500 to provide information on service such as goods to be sold or work to be provided to an information brokering server 510.

Reference numeral 510 denotes an information brokering server, which receives access from a user and brokers information on goods sold by a goods sales entity and work provided by a work providing entity in accordance with a search request from a user.

Reference numeral 520 denotes a user terminal, which accesses the information brokering server 510, gives a search request notification to the information brokering server 510, and receives brokered information provided by the service providing server 500.

Herein, in the conventional information providing system, the relationship among the service providing server 500, the information brokering server 510, and the user terminal 520 and a flow of information exchanged among these three parties are assumed roughly in two ways as shown in FIGS. 5A and 5B.

Hereinafter, for convenience of the description, the case will be described where the entity of the service providing server 500 is a supermarket that sells goods.

The flow of processing in the conventional information providing system in FIG. 5A is roughly as described below.

The service providing server 500 generates information that is desired to be brokered to users, and previously provides it to the information brokering server 510 ((1) provision of information).

Then, a user uses the user terminal 520 to access the information brokering server 510, and makes an information search request ((2) information search).

The information brokering server 510 brokers information in accordance with the information search request ((3) brokering of information). It may also be possible that a user previously specifies the category and kind of information, which is desired to be brokered, in the information brokering server 510 via the user terminal 520, and when the corresponding information is provided by the service providing server 500, it is automatically brokered to the user terminal 520.

Next, the user refers to the brokered information, visits a shop of the operation entity of the service providing server 500, and purchases goods related to the brokered information. At this time, it is also possible to provide the user with an incentive such as a discount ((4) purchase of goods).

A conventional information providing method using the system configuration shown in FIG. 5A may be an information providing method such as conventional newspaper advertisement. A supermarket to be an information providing origin creates advertisement throwaways that contain information (e.g., discount information on bargain goods) on goods whose sales is desired to be promoted, and gives the advertisement throwaways to a newspaper delivery system (corresponding to the above-mentioned process (1): provision of information). The newspaper delivery system distributes the advertisement throwaways. A user browses through the advertisement throwaway to look for desired information (corresponding to the above-mentioned process (2): information search), and obtains favorite goods and discount information thereof (corresponding to the above-mentioned process (3): brokering of information). Thereafter, the user visits the supermarket and purchases the goods at a discount price (corresponding to the above-mentioned process (4): purchase of goods). In this case, any user visiting the shop can purchase the goods at a discount price, irrespective of whether the user has seen the advertisement throwaway.

The flow of conventional information providing processing in FIG. 5B is roughly as follows.

The process (1): provision of information and the process (2): information search in FIG. 5B may be the same as the process (1): provision of information and the process (2): information search in FIG. 5A.

Next, in the flow of the information providing processing in the configuration shown in FIG. 5B, information is brokered to a user, and the user is given the right of making a request to a service provider for an incentive ((3) brokering of information and provision of an incentive ID). Herein, the right of making a request for an incentive is given, for example, by providing a user with a discount ticket or by issuing a member card to a user and setting a courtesy price to a person holding the member card.

Then, the user refers to the brokered information, visits a shop that is the operation entity of the service providing server, and purchases the goods ((5) purchase of goods). Upon purchasing the goods, the user is verified that the user holds the right to an incentive request ((4) presentation of an incentive ID), and the goods sales entity or the work providing entity provides an incentive such as a discount only to the user who has verified that the user holds the right to an incentive request. Herein, the user is verified that the user holds the right to an incentive request, for example, by presenting a discount ticket or presenting a member card.

Provision of information by the system configuration in FIG. 5B may be provision of goods advertisement information by a goods discount ticket or provision of advertisement information showing member courtesy price information. In the former case, for example, goods are sold to only a user who presents a goods discount ticket or the like at a discount price. In the latter case, for example, goods are sold to only a user who presents a member card at a member courtesy price. In any case, a user should be verifies that the user holds the right of making a request for an incentive such as a discount by using a special tool such as a discount ticket or a member card.

The above-mentioned conventional information providing system has the following problems.

The first problem is that the effects of information brokering by an information brokering server are not easily understood in the conventional flow of FIG. 5A. More specifically, any user can get an incentive such as a discount. When a user accesses the service providing server 500, it is difficult to determine whether such a user accesses the service providing server 500 by receiving brokered information by the information brokering server 510 and referring to the information, or such a server is a general user accessing the service providing server 500 without receiving brokered information by the information brokering server 510. In the flow of FIG. 5A, the effects of the brokering of information by the information brokering server 510 cannot be determined.

The second problem is that an incentive such as a discount does not directly lead to reference to the information of the information brokering server 510 in the conventional configuration of FIG. 5B. An incentive such as a discount is obtained only by presenting a special certificate such as a courtesy member card and a discount ticket showing that a user holds the right to an incentive request. An incentive is not obtained by receiving brokered information from the information brokering server 510. More specifically, a user is motivated to become a member or obtain a discount ticket, and the user is not motivated to receive brokered information from the information brokering server 510.

The third problem is as follows. In the case where a user previously specifies the category and kind of information desired to be brokered in the information brokering server 510, a large amount of information mixed with information unnecessary to the user is brokered, and desired information may be buried. In active supply of information from the information brokering server to the user terminal (so-called push-type system of providing information), it is assumed that when the information providing system is increased in scale, a large amount of information of the corresponding category and kind is provided, whereby information necessary to a user may be buried.

The fourth problem is that an incentive cannot be provided based on the evaluation of the contents of user access to the information brokering server. More specifically, if the same incentive as that of the other general users is given to a user often accessing an information brokering server and a user having input user information valuable in terms of sales of goods, such as hobbies and favorites of a user in the course of information search, the promotion of use of the information brokering server cannot be expected.

### SUMMARY OF THE INVENTION

Therefore, with the foregoing in mind, it is an object of the present invention to provide an information providing system and method capable of brokering information desired by a user in accordance with a user's search request, and giving an incentive to the user without requesting the user to present a special certificate verifying that the user holds the right to an incentive request, based on appropriate evaluation of the contents of user access to an information brokering server.

In order to achieve the above-mentioned object, an information providing system of the present invention includes: one or a plurality of user terminals; a service providing server for providing service to the user terminal; and an information brokering server for brokering information on contents of service provided by the service providing server to the user terminal. The information brokering server includes: an information brokering part for receiving an information search request from the user terminal, and brokering corresponding information to the user terminal in accordance with the search request; and a user access information control part for notifying the service providing server of user access information generated by evaluating contents of access to the information brokering server by a user, based on an information search action by the user and contents of information brokered to the user. The service providing server includes: an incentive adjusting part for adjusting contents of an incentive to be given to the user based on the user access information notified from the information brokering server, in a case of receiving an information providing request from the user of the user terminal; and an executing part for receiving the information providing request from the user and executing service in accordance with the information providing request according to the contents of the incentive.

Because of the above-mentioned configuration, the information brokering server brokers information on service desired by a user in accordance with a search request by a user and notifies the service providing server of user access information, thereby determining whether or not the user may receive an incentive without requesting the user to present a special certificate verifying the right to an incentive request. Furthermore, in providing an incentive, the information brokering server can appropriately evaluate the contents of user access to the information brokering server and determines the contents of an incentive.

If the information brokering server further includes: an information browsing environment detecting part for detecting information on an information browsing environment of the user terminal; and an information editing part for editing information provided by the service providing server based on the information on the information browsing environment detected by the information browsing environment detecting part, wherein the information brokering part brokers the information edited by the information editing part to the user terminal, information can be brokered in a data format most effective to presentation in accordance with the configuration of a user terminal (e.g., presence/absence of a display, the size of a display, a resolution, possibility of replay of a moving picture, and presence/absence of a loudspeaker).

In particular, in the case where text information can be presented in an information browsing environment of a user terminal, if the information editing part is designed to conduct edition of incorporating banner advertisement in a part of the information provided by the service providing server, banner advertisement can be displayed on an information brokering screen, and an advertisement fee can be obtained from an advertiser.

If the contents of access to the information brokering server by the user are evaluated, considering an information search history of the user and contents of user information included in the information search request by the user, appropriate evaluation can be conducted.

The information brokered to the user terminal in the information brokering server may contain main information and sub-information, wherein the main information may be provided for the information search request from the user, and the sub-information may not provided for the information search request from the user.

As described above, if information to be brokered contains main information and sub-information, another information whose use is desired to be promoted can be brokered with main information in which a user is interested, as a so-called “combination”. In particular, if information of a service providing server different from a service providing server that provides main information is set to be sub-information, information on service of a dealer who hardly deals with the user can be brokered, which can create a new business chance.

In a case where the user notifies the service providing server of an information providing request regarding the sub-information as well as an information providing request regarding the main information, if the incentive adjusting part adjusts the contents of the incentive to be given to the user, based on the user access information and the information providing requests regarding the main information and the sub-information, the use of sub-information can be promoted.

Furthermore, by providing a processing program for realizing the above-mentioned information providing system, the information providing processing of the present invention can be easily realized at low cost, using a personal computer.

These and other advantages of the present invention will become apparent to those skilled in the art upon reading and understanding the following detailed description with reference to the accompanying figures.

### BRIEF DESCRIPTION OF THE DRAWINGS

FIG. 1 schematically shows a configuration and a processing flow of an information providing system of Embodiment 1 according to the present invention.

FIG. 2 schematically shows a configuration and a processing flow of an information providing system of Embodiment 2 according to the present invention.

FIG. 3 schematically shows a configuration and a processing flow of an information providing system of Embodiment 3 according to the present invention.

FIG. 4 shows examples of a recording medium storing a processing program for realizing an information providing system of Embodiment 4 according to the present invention.

FIGS. 5A and 5B show schematic configurations of a conventional information providing system.

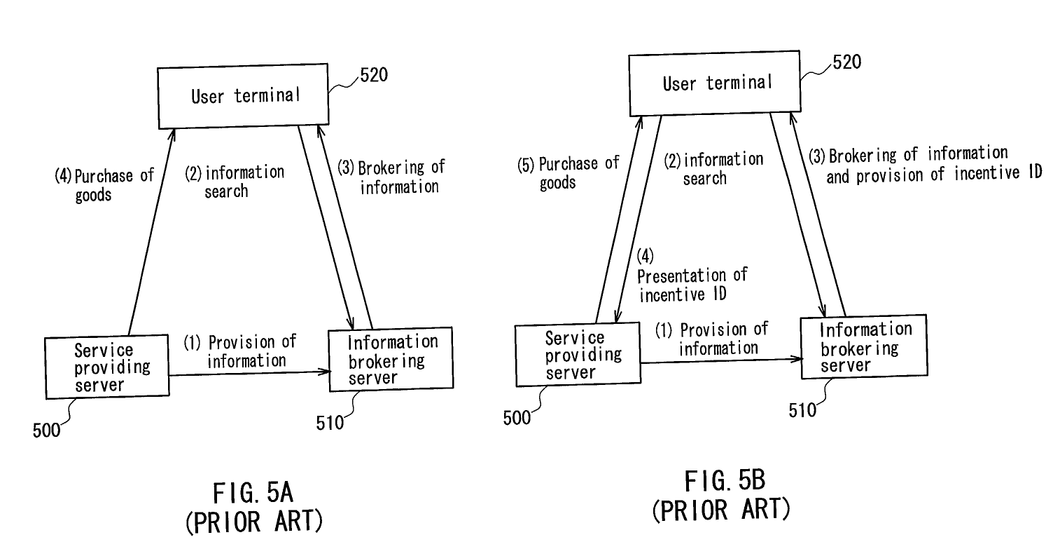

### DESCRIPTION OF THE PREFERRED EMBODIMENTS

An information providing system of the present invention will be described with reference to the drawings.

Embodiment 1

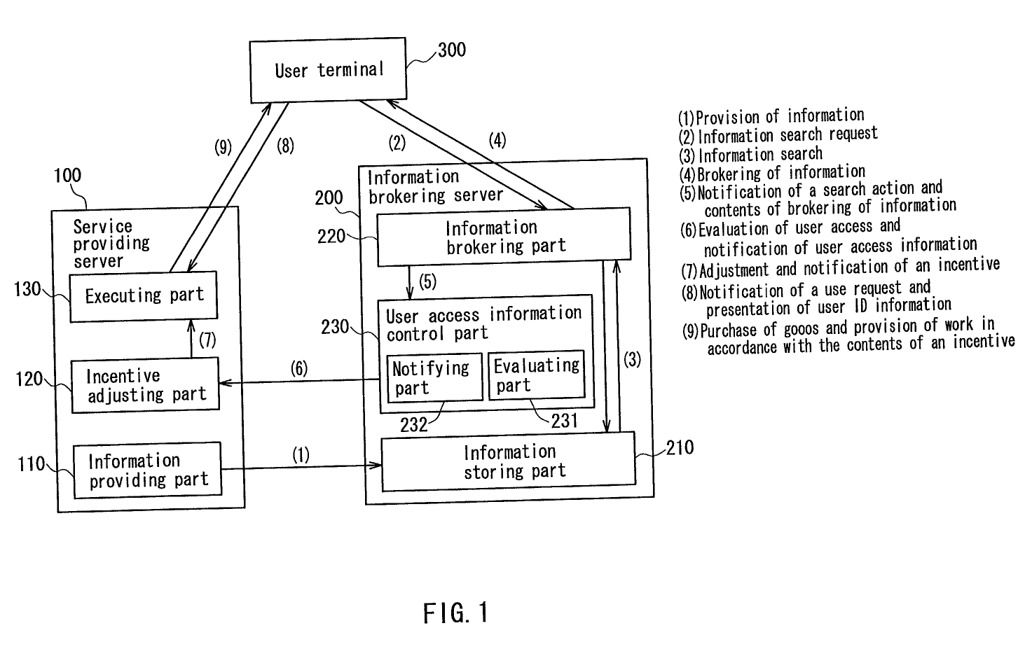

FIG. 1 schematically shows a configuration and a processing flow of an information providing system of Embodiment 1 according to the present invention.

Reference numeral 100 denotes a service providing server, 200 denotes an information brokering server, and 300 denotes a user terminal.

The service providing server 100 includes an information providing part 110, an incentive adjusting part 120, and an executing part 130.

The information providing part 110 provides information on sales of goods and provision of work conducted by an operation entity of the service providing server 100 to the information brokering server 200.

The incentive adjusting part 120 receives user access information notified from the user access information control part 230 of the information brokering server 200, and adjusts the contents of an incentive to be given in the case where a user uses the service providing server 100, based on the user access information.

The executing part 130 executes processing such as sales of goods and provision of work according to the contents of a request from a user, in accordance with the contents of an incentive adjusted by the incentive adjusting part 120.

In the above example, although the incentive adjusting part 120 is included in the service providing server 100, the incentive adjusting part 120 may be included in the information brokering server 200. In this case, the service providing server 100 is notified of instruction information on the adjustment of the contents of an incentive from the incentive adjusting part 120 of the information brokering server 200, and the executing part 130 executes processing according to the contents of a request from a user in accordance with the contents of an incentive based on the instruction information.

The information brokering server 200 includes an information storing part 210, an information brokering part 220, and a user access information control part 230.

The information storing part 210 receives provision of information from the information providing part 110 of the service providing server 100, and stores the information.

The information brokering part 220 receives an information search request notification from a user, searches the information storing part 210 for the corresponding information, and brokers the information to the user terminal 300. Herein, the information search request notification from a user intends to include information allowing a user to be identified. The information allowing a user to be identified may be, for example, user ID information or user speech information. The user ID information allows a user to be identified by matching of ID information. The user speech information allows a user to be identified by matching previously registered user speech information with input speech information. Thus, any information can be used as long as it allows a user to be identified.

For receiving an information search request, the user terminal 300 is provided with a search request interface. For example, an interface for inputting an SQL command used in a database system or an interface for allowing an item to be selected from menu information. Furthermore, in the case where the user terminal 300 has a web browser, an interface for a web browser may be provided for receiving an information search request from the user terminal 300, with the information brokering server 200 being set to be a web server.

The user access information control part 230 includes an evaluating part 231 and a notifying part 232.

The evaluating part 231 evaluates the contents of user access to the information brokering server 200 based on an information search action of a user received by the information brokering part 220 and the contents of information brokered to the user, and generates user access information based on the evaluation results. Herein, the information search action refers to an information search action of a user. The following various information available for evaluation of the contents of access can also be used as information on an information search action. For example, various information available for evaluating a search action includes information useful for identifying a user contained in the above-mentioned information search request notification from a user, information on a search item of service such as the category, contents, price, and quality of service inputted by a user, information on the use of a search, such as information on when a search is conducted and a search frequency, and information on a user, such as a name, a gender, an age, and an annual income input by a user.

Various evaluations of the contents of access are assumed. For example, among the contents of the above-mentioned information search action and the information brokered to a user, information useful for identifying a user and information brokered to a user may be extracted as user access information. Furthermore, information on the above-mentioned information search action and information brokered to a user are evaluated using an evaluation function, and user access information may be generated so as to contain information on the contents of service brokered to a user and information on the evaluation results converted into numbers by an evaluation function.

There are various evaluation functions. Examples thereof include an evaluation function for evaluating a frequency of an information search by a user, using information search history of a user as a parameter, and an evaluation function for evaluating a past service use record, using the number of times of past service use of the user and the use amount of money as parameters. There is also an evaluation function for evaluating the contents of individual information disclosed by a user, using user information contained in a search request notification by the user. Examples of the user information include a user ID, an age, a gender, a family, an annual income, hobbies and favorites, things which a user is planning to purchase, and the like. The contents of individual information disclosed by a user are evaluated using an evaluation function in which these items are weighted.

Evaluation results obtained by a plurality of evaluation functions may be combined.

The notifying part 232 notifies the service providing server 100 of user access information evaluated by the evaluating part 231.

A processing flow of the information providing system of the present invention based on the configuration in FIG. 1 is as follows.

(1) Provision of Information

First, a service providing server 100 provides information desired to be brokered to an information brokering server 200. Information on goods sold by and work provided by an operation entity of the service providing server 100 is provided from an information providing part 110 to an information brokering server 200. As such information, various information contents such as the specification and quality of goods, the contents and quality of work, a price, and features are assumed. Furthermore, information on an incentive such as discount information may be contained.

The information brokering server 200 stores the information received from the information providing part 110 of the service providing server 100 in an information storing part 210. After storing the information in the information storing part 210, the information brokering server 200 waits for an information search request from a user terminal 300.

(2) Information search request

A user accesses an information brokering part 220 of the information brokering server 200 by using a user terminal 300, and makes a desired information search request. In this example, menu information is displayed to the user terminal 300 from the information brokering server 200 as an interface of an information request, and an information search request is made to the information brokering server 200 by selection of the menu.

Herein, it is assumed that a user “A” makes a search request regarding information on goods “a”.

(3) Information Search

The information brokering part 220 retrieves corresponding information from the information storing part 210 in accordance with the information search request received from the user terminal 300.

(4) Brokering of Information

The information brokering part 220 brokers the information retrieved from the information storing part 210 to the user terminal 300 and allows a user to browse through the information.

Herein, it is assumed that the user “A” receives brokered information on the goods “a” provided by the service providing server 100.

(5) Notification of a Search Action and Contents of Brokered Information

The information brokering part 220 of the information brokering server 200 notifies the user access information control part 230 of the contents of a user search action and brokered information through the user terminal 300, together with the above-mentioned brokered information.

Examples of the contents of a user search action include a search request item presented by a user and user information contained in a search request notification by the user in the course of information search. As the user information, as described above, the following can be assumed: a user ID, an age, a gender, a family, an annual income, hobbies and favorites, and things which a user is planning to purchase.

The contents of brokered information refer to those of information browsed through by a user. For example, in the case where there are a plurality of service providing servers 100, the following information is assumed: information regarding which information provided by which information providing service is brokered, and information regarding which information on which goods and on which work is brokered.

Herein, the contents of a search action on the goods “a” of the user “A”, and the contents of the brokered information are notified.

(6) Evaluation of User Access and Notification of User Access Information

First, the user access information control part 230 receives a notification of the contents of a user search action and the contents of brokered information from the information brokering part 220, evaluates user access using the evaluating part 231, and creates user access information.

Evaluation of the user access in the evaluating part 231 is conducted, for example, by calculating an evaluation value, using a predetermined evaluation function, as described above.

Next, the user access information control part 230 notifies the service providing server 100 of the user access information evaluated and created by the evaluating part 231 through the notifying part 232.

Herein, the access by the user “A” is evaluated, and the service providing server 100 is notified of the user access information.

(7) Adjustment and Notification of the Contents of an Incentive

Upon receiving a notification of the user access information from the user access information control part 230 of the information brokering server 200, the incentive adjusting part 120 adjusts the contents of an incentive to be given on the user basis in accordance with the user access information.

Herein, for example, an incentive in which the goods “a” are sold at a 10% discount price is set with respect to the user “A”. The adjustment of the contents of an incentive can be conducted on the user basis and on the goods basis. For example, the goods “a” are sold to a user “B” at a 15% discount price, the goods “a” are sold to a user “C” at a 20% discount price, and the goods “b” are sold to the user “C” at a 25% discount.

The incentive adjusting part 120 notifies an executing part 130 of information on the contents of an incentive that have already been adjusted.

Herein, the executing part 130 is notified of the contents of an incentive that the goods “a” are sold to the user “A” at a 10% discount price.

(8) Notification of a Use Request and Presentation of User ID Information

A user who has utilized brokered information from the information brokering server 200 through the user terminal 300 makes a use request to a goods dealer or a work provider that is an entity of the service providing server 100, referring to information on brokering. The executing part 130 receives the use request.

Herein, it is assumed that a purchase request for the goods “a” is made.

A user makes a use request to a goods dealer or a work provider that is an entity of the service providing server 100, and presents user ID information. The user ID information is used for just specifying a user, and is not a special certificate verifying the right to an incentive request as in the conventional example.

Herein, the user “A” presents user ID information, and the executing part 130 identifies the user “A”.

In the present embodiment, the executing part 130 provides an interface for receiving a use request. However, a user interface portion may be provided separately from the executing part 130.

(9) Purchase of Goods and Provision of Work in Accordance with the Contents of an Incentive

The executing part 130 checks the contents of an incentive that have been adjusted with respect to a user of interest among the contents of an incentive notified in the above process (6).

Herein, since the user is “A”, the contents of an incentive are adjusted so that the goods “a” are sold at a 10% discount price.

The executing part 130 executes the contents of a use request in accordance with the contents of an incentive.

Herein, the contents of a user request notification of the user “A” is a purchase request for the goods “a”. Therefore, the goods “a” are sold at a 10% discount price. The user “A” can receive an incentive adjusted with respect to the user “A” without presenting a special certificate verifying the right to an incentive request to the service providing server 100. For example, even if a user “D” makes a purchase request for the goods “a”, since the user “D” has not received brokered information on the goods “a” through the information brokering server 200, no incentive is set. Therefore, unlike the user “A”, the user “D” cannot purchase the goods “a” at a discount price.

The features of the present embodiment are as follows. The user “A” makes an information search request to an information brokering server, and receives brokering of the corresponding information. The information brokering server 200 notifies the service providing server 100 of user access information in which the contents of such a search action and brokered information are evaluated, and the contents of an incentive are adjusted dynamically in the service providing server 100.

In the above-mentioned description, the order of the process (7): notification of the contents of an incentive from the incentive adjusting part 120 to the executing part 130 and the process (8): notification of a user request and presentation of user ID information may be reversed. For example, the following may be possible: user ID information is presented, a notification of a user's use request is received, and the contents of an incentive adjusted with respect to the user is notified.

As described above, the information providing system of the present invention brokers information desired by a user in accordance with a user search request, and appropriately evaluates the contents of user access to an information brokering server to give an incentive, without requesting presentation of a special certificate showing that the user can receive an incentive.

Embodiment 2

An information providing system of Embodiment 2 will be described.

The information providing system of Embodiment 2 detects an information browsing environment at a user terminal used by a user, edits information to be brokered in accordance with the user terminal's information browsing environment, and executes brokering of information in a data format most effective for presentation on the user terminal.

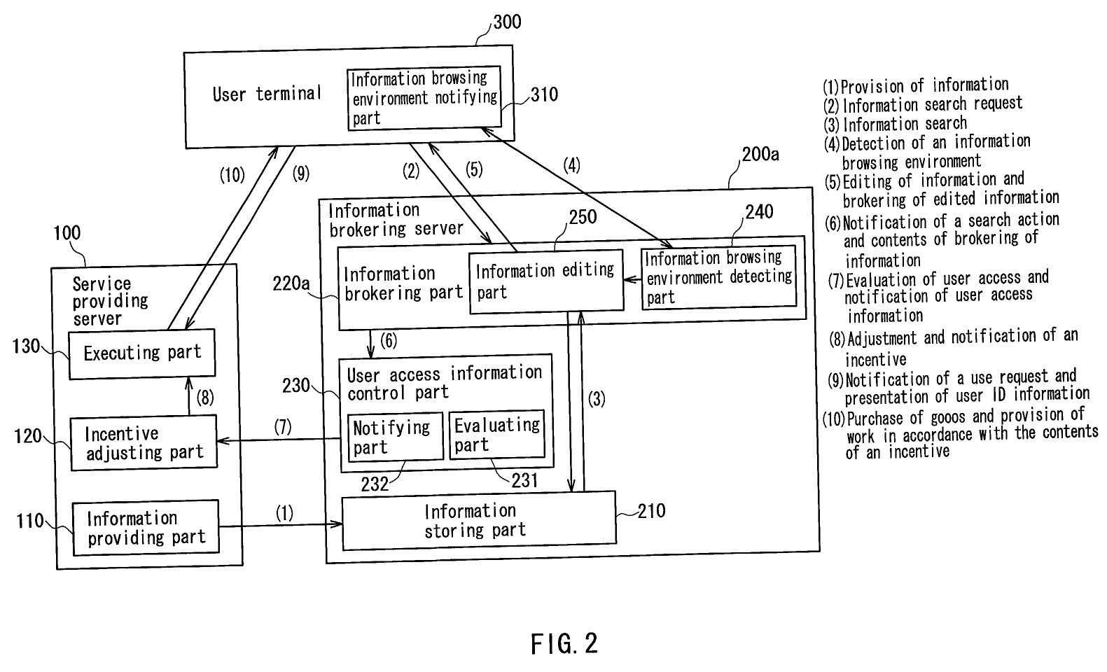

FIG. 2 schematically shows a configuration and a processing flow of the information providing system of Embodiment 2 according to the present invention.

The configuration of the service providing server 100 may be the same as that in FIG. 1. However, the system configuration of an information brokering server 200a is different from that of the information brokering server 200 in FIG. 1.

The information brokering server 200a further includes an information browsing environment detecting part 240 and an information editing part 250, in addition to the information storing part 210, the information brokering part 220a, and the user access information control part 230. In the example shown in FIG. 2, the information brokering part 220a includes the information browsing environment detecting part 240 and the information editing part 250. However, the information browsing environment detecting part 240 and the information editing part 250 may not be included in the information brokering part 220a.

The information browsing environment detecting part 240 detects an information browsing environment of the user terminal 300, and notifies the information editing part 250 of information on the detected information browsing environment.

Herein, the information browsing environment in the user terminal 300 refers to an environment of the user terminal 300 regarding presentation of the user terminal 300, such as the presence/absence of a display, the size of a display, the resolution, the possibility of replay of a moving picture, and the presence/absence of a loudspeaker. An information browsing environment notifying part 310 is provided in the user terminal 300, and the information browsing environment detecting part 240 of the information brokering server detects information browsing environment information of a user previously registered. Thus, a procedure for exchanging information browsing environment information in the user terminal 300 is determined between the information browsing environment detecting part 240 of the information brokering server 200a and the information browsing environment notifying part 310 of the user terminal 300.

The information browsing environment detecting part 240 inquires about the information browsing environment with respect to the user terminal 300, and obtains information on the information browsing environment from the user terminal 300.

As an easy method for detecting an information browsing environment without requiring the information browsing environment notifying part 310 on the user terminal 300 side, the following methods can be used. First, in the case where a communication system used with respect to the user terminal 300 is a public line, if so-called Directory Assistance is used, whether the user terminal 300 is a mobile phone or a fixed phone can be detected. Second, in the case where a communication system used with respect to the user terminal 300 is an electronic mail system, whether the user terminal 300 is a personal computer or a mobile phone connected on the Internet can be detected from an electronic mail address.

The information editing part 250 edits information obtained from the information storing part 210 through a search in the information brokering part 220a in accordance with an information browsing environment notified from the information browsing environment detecting part 240.

For example, in the case where a display is equipped in the information browsing environment of the user terminal 300, information is edited as text information and image information, and is further edited considering a data display ability of a display. For example, in the case where the user terminal 300 is a mobile phone only with a small liquid crystal screen, brokered information can be edited only with text information. In the case where the user terminal 300 is a personal computer capable of replaying a moving picture, brokered information can be edited in combination with text information, still image information, and moving picture information. Furthermore, in the case where there is a loudspeaker in the information browsing environment of the user terminal 300, speech information can also be edited.

The information editing part 250 is preferably provided with a banner environment editing function. The information editing part 250 uses such a function to incorporate banner advertisement in a part of brokered information. Since banner advertisement is assumed to be short text information, it is required that text information can be presented in an information browsing environment of the user terminal. For example, in the case where the user terminal 300 is a personal computer with a display, a mobile phone with a liquid crystal display screen, or a car navigation system with a liquid crystal display screen, short text information and the like can be displayed. Therefore, banner advertisement is displayed in a part of an information brokering screen. If brokered information incorporating banner advertisement is edited as described above, other goods can be effectively advertised together with brokering of information to a user, and a business chance of collecting an advertisement fee from a advertiser can be enlarged.

Information on banner advertisement to be incorporated may be previously held in the information editing part 250, or may be given dynamically from outside.

A processing flow of the information providing system of Embodiment 2 based on the configuration in FIG. 2 is as follows. The description of the portions similar to those of the processing flow shown in FIG. 1 will be omitted, and only different portions will be described.

(1) Provision of Information

In the same way as in Embodiment 1 shown in FIG. 1, the service providing server 100 provides information desired to be brokered to the information brokering server 200a. The information brokering server 200a stores information received from the information providing part 110 of the service providing server 100 in the information storing part 210. After storing the information provided by the service providing server 100 in the information storing part 210, the information brokering server 200a waits for an information search request from the user terminal 300.

(2) Information Search Request

In the same way as in Embodiment 1 shown in FIG. 1, a user uses the user terminal 300 to access the information brokering part 220a of the information brokering server 200a, and gives a search request notification of desired information.

(3) Information Search

The information brokering part 220a retrieves corresponding information from the information storing part 210 in accordance with an information search request notification received from the user terminal 300. The retrieved information is inputted in the information editing part 250.

(4) Detection of an Information Browsing Environment

The information brokering part 220a detects an information browsing environment of the user terminal 300 through the information browsing environment detecting part 240. For example, the information browsing environment detecting part 240 inquires about the information on an information browsing environment of the user terminal 300 with respect to the user terminal 300, and the user terminal 300 provides information on a system environment regarding presentation of the user terminal 300, such as the presence/absence of a display, the size of a display, the resolution, the possibility of replay of a moving picture, and the presence/absence of a loudspeaker.

The information browsing environment detecting part 240 notifies the information editing part 250 of information on the information browsing environment obtained from the user terminal 300.

(5) Editing of Information and Brokering of Edited Information

The information editing part 250 edits information given as a result of an information search in the process (3) in accordance with the information browsing environment notified from the information browsing environment detecting part 240. As described above, in an application conducting editing in which banner advertisement is incorporated, banner advertisement introduction processing is conducted.

The information editing part 250 brokers the edited information to the user terminal 300, and allows a user to browse through it.

The process (6): Notification of a search action and the contents of brokering to the process (10): Purchase of goods and provision of work in accordance with the contents of an incentive are the same as those in the processes (5) to (9) of Embodiment 1 shown in FIG. 1. Therefore, the description thereof will be omitted here.

In the same way as in Embodiment 1, the order of the process (8): notification of the contents of an incentive from the incentive adjusting part 120 to the executing part 130 and the process (9): use request and presentation of user ID information may be reversed.

As described above, the information providing system of Embodiment 2 can detect an information browsing environment of a user terminal used by a user, edits information to be brokered in accordance with an information browsing environment, and executes brokering of information in a data format most effective for presentation.

Embodiment 3

An information providing system of Embodiment 3 will be described.

In the information providing system of Embodiment 3, information brokered to a user terminal by an information brokering server includes main information and sub-information. The main information is related to an information search request from a user, and the sub-information is related to information other than that related to an information search request from a user. Main information that is requested for a search from a user is brokered to a user under the condition of being combined with sub-information.

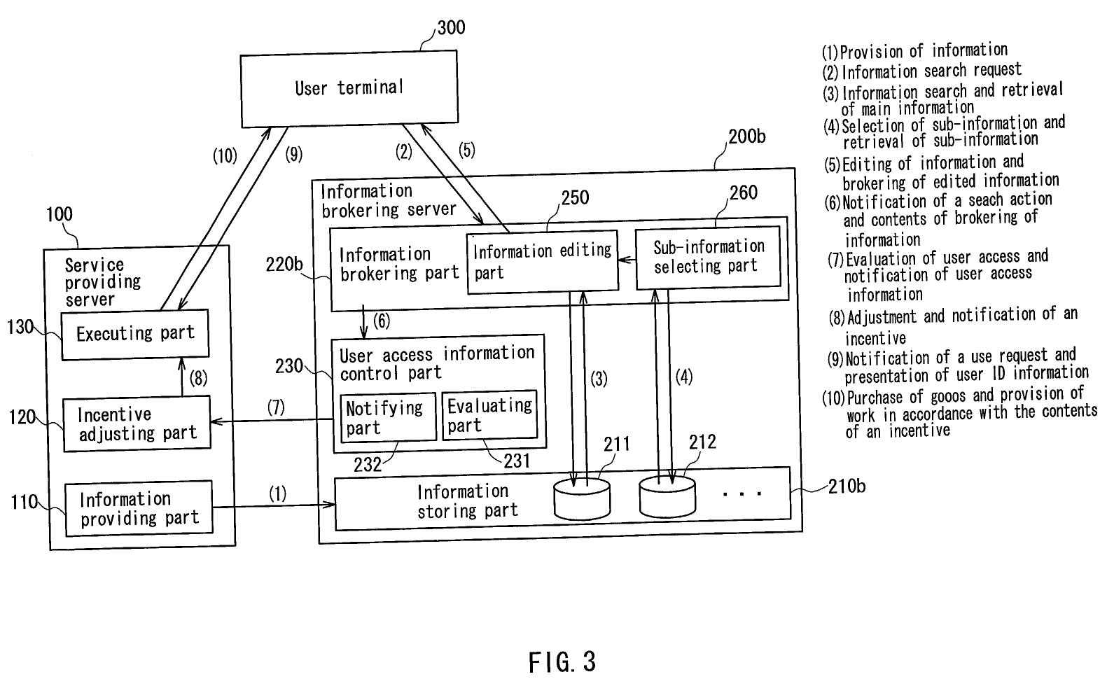

FIG. 3 schematically shows a configuration and a processing flow of the information providing system of Embodiment 3 according to the present invention.

The configuration of the service providing server 100 may be the same as that of Embodiment 1 shown in FIG. 1. However, the system configuration of the information brokering server 200b is different from that of the information brokering server 200 in FIG. 1.

The information brokering server 200b further includes an information editing part 250 and a sub-information selecting part 260, in addition to an information storing part 210b, an information brokering part 220b, and a user access information control part 230. In the example in FIG. 3, although the information brokering part 220b includes the information editing part 250 and the sub-information selecting part 260, the information editing part 250 and the sub-information selecting part 260 may not be included in the information brokering part 220b.

The information storing part 210b manages provided information on the service providing server basis. The information storing part 210b includes a partition region 211 for storing provided information on the service providing server basis. In this example, for convenience of the drawing, only one service providing server 100 is shown. However, it is assumed that there are two service providing servers and two partition regions 211 and 212 are provided so as to correspond to the respective service providing servers.

The sub-information selecting part 260 selects sub-information to be combined with main information related to an information search request of the user terminal 300. In this example, it is assumed that the sub-information selecting part 260 previously holds a rule for selecting sub-information.

The rule for selecting sub-information is not particularly limited. For example, there is a rule for previously associating each information with another information, and selecting information associated with main information that is requested for an information search, as sub-information. Information on goods having a relationship is associated with each other (for example, information on a personal computer is associated with information on a digital camera).

There is another rule for selecting information provided by a different service providing server different from the server that provides main information, as sub-information. If sub-information is selected in accordance with this rule, even information that is not requested for an information search may be brokered to a user.

There is still another rule for allowing an operation entity of a service providing server to provide a user list, and preferentially selecting information provided by the operation entity even when a user of the user terminal 300 is not included in the provided user list. If sub-information is selected in accordance with this rule, goods information of a dealer who hardly deals with a user and whose user list does not contain the user can be brokered to a user, which allows a new business chance to be created.

The information editing part 250 edits information to be brokered to the user terminal 300 from main information obtained from the information storing part 210 by a search in the information brokering part 220b and sub-information obtained from the sub-information selecting part 260.

The processing flow of the information providing system of Embodiment 3 based on the configuration in FIG. 3 is as follows. The description of the processing flow shown in FIG. 1 and the portions similar to those therein will be simplified, and the description of different portions will be described.

(1) Provision of Information

The service providing server 100 provides information desired to be brokered to the information brokering server 200b. The information brokering server 200b stores the information received from the service providing server 100 in the information storing part 210b. In this example, it is assumed that there are two service providing servers 100. The information brokering server 200b receives information from the respective service providing servers 100, and stores one information in the partition region 211 of the information storing part 210b and the other information in the partition region 212.

The information brokering server 200b has an information search request from the user terminal 300.

(2) Information Search Request

In the same way as in Embodiment 1 shown in FIG. 1, a user uses the user terminal 300 to access the information brokering part 220b of the information brokering server 200b, thereby making a search request for desired information.

(3) Information Search and Retrieval of Main Information

The information brokering part 220b retrieves corresponding information from the information storing part 210b in accordance with an information search request received from the user terminal 300. Herein, the retrieved information is given to the information editing part 250. The information thus retrieved is main information.

(4) Selection of Sub-information and Retrieval of Sub-information

The sub-information selecting part 260 of the information brokering part 220b selects sub-information to be combined with main information, and retrieves the sub-information from the information storing part 210b.

The retrieved sub-information is given to the information editing part 250.

(5) Editing of Information and Brokering of Edited Information

The information editing part 250 edits the main information retrieved in the process (3) in combination with the sub-information retrieved in the process (4).

The information editing part 250 brokers the edited information to the user terminal 300, and allows a user to browse through it.

(6) Notification of a Search Action and Contents of Brokered Information

In the same way as in Embodiment 1 shown in FIG. 1, a search action and a notification of the contents of information brokering are conducted. Herein, the information brokering part 220b notifies the user access information control part 230 of the contents of brokered main information and sub-information. Furthermore, there are a plurality of service providing servers 100, so that the information brokering part 220b also notifies the user access information control part 230 of the information regarding which information provided by which information providing service is brokered, and information regarding which information on which goods and on which work is brokered.

(7) Evaluation of User Access and Notification of User Access Information

The evaluating part 231 of the user access information control part 230 evaluates user access to the information brokering server 200b, considering the combination of main information and sub-information, and creates user access information. Multilateral evaluation, such as evaluation of main information, evaluation of sub-information, and evaluation in the case where main information is combined with sub-information, can be conducted.

The user access information control part 230 notifies the service providing server 100 via the notifying part 232 of the user access information evaluated and created by the evaluating part 231.

(8) Adjustment and Notification of the Contents of an Incentive

Upon receiving a notification of the user access information from the user access information control part 230 of the information brokering server 200b, the incentive adjusting part 120 adjusts the contents of an incentive to be provided in accordance with an evaluation value of user access information on the user basis.

Herein, in the case where a use request for sub-information as well as a use request for main information are made, it is effective to set an incentive to be high. For example, in the case where an incentive is set so that goods “a” regarding main information and goods “b” regarding sub-information are sold at a 10% discount price, respectively, a high incentive is set in such a manner that when the goods “a” and the goods “b” are purchased together, they are sold at a 20% discount price, respectively.

The incentive adjusting part 120 notifies the executing part 130 of the information regarding the adjusted contents of an incentive.

The process (9): Notification of a use request and presentation of user ID information and the process (10): Purchase of goods and provision of work in accordance with the contents of an incentive are the same as the processes (8) and (9) in Embodiment 1 shown in FIG. 1. Therefore, the description thereof will be omitted here.

In the same way as in Embodiment 1, the order of the process (8): notification of the contents of an incentive from the incentive adjusting part 120 to the executing part 130 and the process (9): use request and presentation of user ID information may be reversed.

As described above, in the information providing system of Embodiment 3, information to be brokered contains main information and sub-information, and main information in which a user is interested can be brokered in combination of another information whose use is desired to be promoted. In particular, if information of a service providing server different from a service providing server that provides main information is set to be sub-information, information of a dealer who hardly deals with the user can be brokered, which creates a new business chance.

Embodiment 4

In an information providing system of Embodiment 4, information exchanged in the information providing systems described in Embodiments 1 to 3 is made speech information, and the idea of a voice portal using a speech is applied to an information providing system.

A user inputs a search request with a speech through a user terminal. The user terminal is equipped with a speech recognition function that recognizes the contents of an information search request inputted with a speech and converts the contents into text data. Furthermore, a speech feature value is extracted from the inputted speech information, and the text data representing an information search request and the speech feature value are sent to an information brokering server as an information search request notification.

The information brokering server extracts the speech feature value contained in the information search request notification as information useful for identifying a user, and searches for information and brokers corresponding information to the user in accordance with the information search request notification in the same way as in Embodiments 1 to 3.

The user access information control part of the information brokering server sends the speech feature value included in the user access information to the service providing server.

The user inputs an information providing request notification with a speech with respect to the service providing server.

The service providing server recognizes the contents of the information providing request notification with a speech, extracts the speech feature value of the user, and matches the extracted speech feature value with the speech feature value of the user received from the information brokering server. As a result of matching, a user is specified.

In the same way as in Embodiments 1 to 3, the service providing server allows the incentive adjusting part to adjust the contents of an incentive given to the user based on user access information notified from the information brokering server. The user can receive an incentive determined with respect to service use.

As described above, in the information providing system of Embodiment 4 using speech information, a user is specified with a speech feature value, so that it is not required to present user ID information to the service providing server.

Embodiment 5

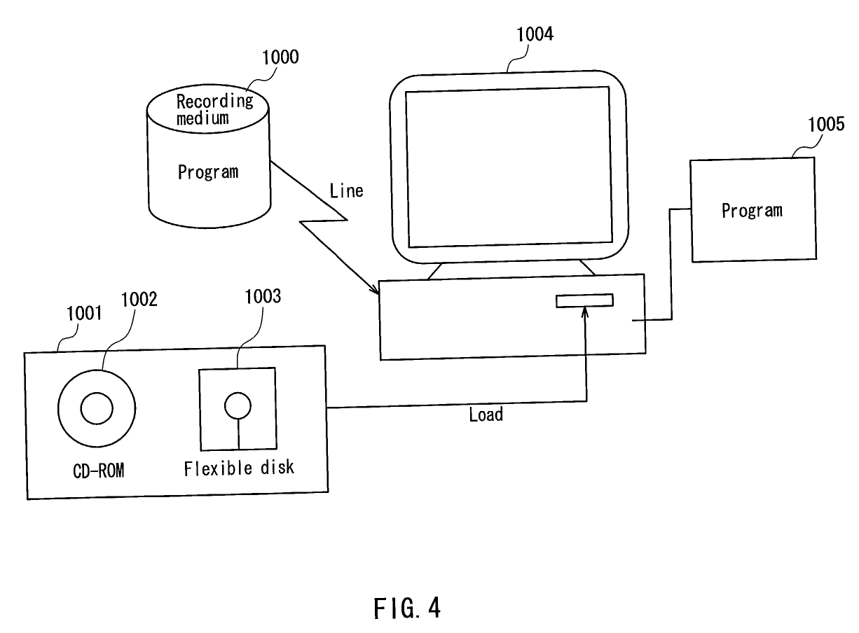

In the information providing system of the present invention, processing operations for realizing the above-mentioned configuration can be described as a program, and a computer is allowed to read the program, whereby the information providing system of the present invention can be configured. The program including processing operations for realizing the information providing system of the present invention is stored in a recording medium 1000 in a recording apparatus on a network and a recording medium 1005 such as a hard disk and a RAM of a computer, as well as a portable recording medium 1001 such as a CD-ROM 1002 and a flexible disk 1003, as shown in FIG. 4, and the program can be downloaded from a network. In execution, the program is loaded onto a computer 1004, and executed on a main memory.

According to the information providing system and method of the present invention, information desired by a user is brokered in accordance with a user's search request, and based on appropriate evaluation of the contents of user access to an information brokering server, an incentive is given to the user without requesting the user to present a special certificate verifying that the user holds the right to an incentive request.

Furthermore, according to the information providing system and method of the present invention, an information browsing environment of a user terminal used by a user is detected, information to be brokered is edited in accordance with the information browsing environment, and information brokering is executed in a data format most effective to presentation.

Furthermore, according to the information providing system and method of the present invention, information in which a user is interested can be brokered in combination with another information whose use is desired to be promoted. In particular, if information of a service providing server different from a service providing server that provides main information is set to be sub-information, information of a dealer who hardly deals with the user can be brokered, which creates a new business chance.

The invention may be embodied in other forms without departing from the spirit or essential characteristics thereof. The embodiments disclosed in this application are to be considered in all respects as illustrative and not limiting. The scope of the invention is indicated by the appended claims rather than by the foregoing description, and all changes which come within the meaning and range of equivalency of the claims are intended to be embraced therein.

What is claimed is:

1. An information providing system, comprising: one or a plurality of user terminals; a service providing server for providing service to the user terminal; and an information brokering server for brokering information on contents of service provided by the service providing server to the user terminal,
wherein the information brokering server comprises:
an information brokering part for receiving an information search request from the user terminal, and brokering corresponding information to the user terminal in accordance with the search request; and
a user access information control part for notifying the service providing server of user access information generated by evaluating contents of access to the information brokering server by a user, based on an information search action by the user and contents of information brokered to the user, and
the service providing server comprises:
an incentive adjusting part for adjusting contents of an incentive to be given to the user based on the user access information notified from the information brokering server, in a case of receiving an information providing request from the user of the user terminal; and
an executing part for receiving the information providing request from the user and executing service in accordance with the information providing request according to the contents of the incentive.

2. An information providing system according to claim 1, wherein the information brokering server further comprises:
an information browsing environment detecting part for detecting information on an information browsing environment of the user terminal; and
an information editing part for editing information provided by the service providing server based on the information on the information browsing environment detected by the information browsing environment detecting part,
wherein the information brokering part brokers the information edited by the information editing part to the user terminal.

3. An information providing system according to claim 2, wherein, in a case where it is detected from the information on the information browsing environment that text information can be presented at the user terminal, the information editing part conducts edition of incorporating banner advertisement in a part of the information provided by the service providing server.

4. An information providing system according to claim 1, wherein the user access information control part in the information brokering server evaluates the contents of access to the information brokering server by the user, considering an information search history of the user and contents of user information included in the search request by the user.

5. An information providing system according to claim 1, wherein the information brokered to the user terminal in the information brokering server contains main information and sub-information,
the main information is retrieved based on the information search request from the user, and
the sub-information is not retrieved based on the information search request from the user.

6. An information providing system according to claim 5, wherein, in a case where the user notifies the service providing server of an information providing request regarding the sub-information as well as an information providing request regarding the main information, the incentive adjusting part adjusts the contents of the incentive to be given to the user, based on the user access information and the information providing requests regarding the main information and the sub-information.

7. An information providing system according to claim 5, wherein there are a plurality of the information brokering servers,
the main information corresponds to an information search request from the user, and
the sub-information is provided by a service providing server other than a service providing server that provides the main information.

8. An information providing system according to claim 1, wherein the incentive adjusting part adjusts the contents of the incentive to be given to the user, based on the user access information and an information providing request history of the user.

9. An information brokering server for brokering information on contents of service of a service providing server that provides service to one or a plurality of user terminals, comprising:
an information brokering part for receiving an information search request from the user terminal, and brokering corresponding information to the user terminal in accordance with the search request; and
a user access information control part for notifying the service providing server of user access information generated by evaluating contents of access to the information brokering server by the user, based on contents of an information search action by the user and contents of information brokered to the user.

10. A method for providing information using one or a plurality of user terminals, a service providing server for providing service to the user terminal, and an information brokering server for brokering information on contents of service that can be provided by the service providing server to the user terminal,
wherein the information brokering server receives an information search request from the user terminal, brokers corresponding information to the user terminal in accordance with the search request, and notifies the service providing server of user access information generated by evaluating contents of access to the information brokering server by the user, based on an information search action by the user and contents of information brokered to the user, and
the service providing server adjusts contents of an incentive to be given to the user based on the user access information notified from the information brokering server, in a case of receiving an information providing request from a user of the user terminal, receives the information providing request from the user, and executes service in accordance with the information providing request according to the contents of the incentive.

11. A program for conducting information providing processing using one or a plurality of user terminals, a service providing server for providing service to the user terminal, and an information brokering server for brokering information on contents of service that can be provided by the service providing server to the user terminal,
wherein a program of the information brokering server comprises:
information brokering processing of receiving an information search request from the user terminal, and brokering corresponding information to the user terminal in accordance with the search request; and
user access information control processing of notifying the service providing server of user access information generated by evaluating contents of access to the information brokering server by the user, based on an information search action by the user and contents of information brokered to the user, and
a program of the service providing server comprises:
incentive adjusting processing of adjusting contents of an incentive to be given to the user based on the user access information notified from the information brokering server, in a case of receiving an information providing request from a user of the user terminal; and
execution processing of receiving the information providing request from the user, and executing service in accordance with the information providing request according to the contents of the incentive.
